(19) United States
(12) Patent Application Publication
(10) Pub. No.: US 2023/0158440 A1
(43) Pub. Date: May 25, 2023

(54) EFFLUENT GAS TREATMENT APPARATUS

(71) Applicant: Edwards Limited, Burgess Hill, West Sussex (GB)

(72) Inventors: Arani Elanganathan, Burgess Hill, Sussex (GB); Christopher Paul Williams, Burgess Hill, Sussex (GB); Anna Victoria Howbrook, Burgess Hill, Sussex (GB); Gareth David Stanton, Burgess Hill, Sussex (GB)

(21) Appl. No.: 17/907,613

(22) PCT Filed: Mar. 24, 2021
(86) PCT No.: PCT/GB2021/050716

§ 371 Date: Sep. 28, 2022

(30) Foreign Application Priority Data
Mar. 31, 2020 (GB) 2004688.4

(51) Int. Cl. B01D 49/00; B01D 53/34

(52) U.S. Cl. CPC B01D 49/00; B01D 53/346

(57) ABSTRACT

Apparatus and methods are disclosed. The apparatus comprises: an abatement chamber of an abatement apparatus which treats an effluent stream from a semiconductor processing tool to provide a combusted effluent stream having effluent particles; and a first atomiser located downstream of the abatement chamber, the first atomiser being configured to produce droplets having a droplet size based on a particle size of the effluent particles to be removed from the combusted effluent stream. In this way, the atomizer may produce droplets which combine with or adhere to the effluent particles which assists in the removal of the effluent particles from the combusted effluent stream.

This application is a Section 371 National Stage Application of International Application No. PCT/GB2021/050716, filed Mar. 24, 2021, and published as WO 2021/198646A1 on Oct. 7, 2021, the content of which is hereby incorporated by reference in its entirety and which claims priority of British Application No. 2004688.4, filed Mar. 31, 2020.

### FIELD

The present invention relates to apparatus and methods. Embodiments relate to apparatus for treating an effluent stream containing solid particles such as, for example, SiO₂ and acidic gases such as HCl.

### BACKGROUND

Abatement treatment apparatus are known. Such apparatus are used for treatment of effluent gases arising from, for example, epitaxial deposition or other semiconductor fabrication processes. Epitaxial deposition processes are increasingly used for high-speed semiconductor devices, both for silicon and compound semiconductor applications. An epitaxial layer is a carefully grown, single crystal silicon film. Epitaxial deposition utilises a silicon source gas, typically silane or one of the chlorosilane compounds, such as trichlorosilane or dichlorosilane, in a hydrogen atmosphere at high temperature, typically around 800-1100° C., and under a vacuum condition. Epitaxial deposition processes are often doped with small amounts of boron, phosphorus, arsenic, germanium or carbon, as required, for the device being fabricated. Etching gases supplied to a process chamber may include halocompounds such as HCl, HBr, BCl₃, Cl₂ and Br₂, and combinations thereof. Hydrogen chloride (HCl) or another halocompound, such as SF₆ or NF₃, may be used to clean the chamber between process runs.

In such processes, only a small proportion of the gas supplied to the process chamber is consumed within the process chamber, and so a high proportion of the gas supplied to the process chamber is exhausted from the process chamber, together with solid and gaseous by-products from the process occurring within the chamber. A process tool typically has a plurality of process chambers, each of which may be at respectively different stages in a deposition, etching or cleaning process. Therefore, during processing a waste effluent stream formed from a combination of the gases exhausted from the chambers may have various different compositions.

Before the waste stream is vented into the atmosphere, it is treated to remove selected gases and solid particles therefrom using the abatement apparatus. Acid gases such as HF and HCl are commonly removed from a gas stream using a packed tower scrubber, in which the acid gases are taken into solution by a scrubbing liquid flowing through the scrubber. Silane is pyrophoric, and so before the waste stream is conveyed through the scrubber it is common practice for the waste stream to be conveyed through a thermal incinerator or abatement chamber to react silane or other pyrophoric gas present within the waste stream with air. Any perfluorocompounds such as NF₃ may also be converted into HF within the abatement chamber.

When silane burns, large amounts of silica (SiO₂) particles are generated. Other compounds also produce particles when exposed to heat. Whilst many of these particles may be taken into suspension by the weir and quench nozzles, it has been observed that the capture of relatively smaller particles (for example, having a size less than 1 micron) by the scrubbing liquid is relatively poor.

Although such apparatus provide for treatment of the effluent gas stream, they have a number of shortcomings. Accordingly, it is desired to provide an improved abatement apparatus.

The discussion above is merely provided for general background information and is not intended to be used as an aid in determining the scope of the claimed subject matter. The claimed subject matter is not limited to implementations that solve any or all disadvantages noted in the background.

### SUMMARY

According to a first aspect, there is provided an apparatus, comprising: an abatement chamber of an abatement apparatus which treats an effluent stream from a semiconductor processing tool to provide a combusted effluent stream having effluent particles; and a first atomiser located downstream of the abatement chamber, the first atomiser being configured to produce droplets having a droplet size based on a particle size of the effluent particles to be removed from the combusted effluent stream.

The first aspect recognizes that a problem with existing arrangements is that the amount of effluent particles that can be removed from the effluent stream is limited. This may be because the particles remain suspended within the combusted effluent stream and so are difficult to remove. Accordingly, an apparatus is provided. The apparatus may comprise an abatement chamber. The abatement chamber may be provided as part of an abatement apparatus. The abatement apparatus may be configured to treat, process or abate an effluent stream provided by a semiconductor processing tool. The abatement chamber may provide or produce a combusted effluent stream. The combusted effluent stream may have effluent particles suspended therein. The apparatus may comprise an atomizer which may receive the combusted effluent stream from the abatement chamber. The atomizer may be configured or arranged to produce droplets. The droplets may have a droplet size which may be based on, related to, dependent upon or in proportion to the particle size of the effluent particles which are to be removed from the combusted effluent stream. In this way, the atomizer may produce droplets which combine with or adhere to the effluent particles which assists in the removal of the effluent particles from the combusted effluent stream.

The apparatus may comprise a second atomizer located downstream of the first atomizer. Providing a second atomizer enables further droplets to be produced which may combine with effluent particles and/or already combined effluent particles and droplets produced from the first atomizer, which helps to remove these from the combusted effluent stream.

The apparatus may comprise a quench spray section upstream of the first atomiser and a spray nozzle for scrubbing water soluble gases upstream of the second atomiser. Typically, the quench spray section may be located in a quenching stage downstream of the abatement chamber. Typically, the spray nozzle may be located in a packed tower downstream of the first atomizer and upstream of the second atomizer.

The first atomizer may be located downstream of a quenching stage.

The second atomizer may be located towards an entrance of a packed tower.

The second atomizer may be located towards an exhaust of the packed tower. Locating the first atomizer towards one end of the packed tower and the second atomizer towards the other end of the packed tower provides a space for the effluent particles and droplets to adhere or combine and agglomerate to become larger, which assists in their removal from the combusted effluent stream.

The second atomizer may be located upstream of a cyclone or a mist filter. Again, this helps to create larger particles which can be more effectively removed. The cyclone or the mist filter primarily removes moisture from the effluent stream. The cyclone/mist filter may remove particulates in combination with the top atomiser.

The first atomizer and/or the second atomizer may be configured to produce droplets which have a droplet size distribution based on a particle size distribution of the effluent particles to be removed from the combusted effluent stream. Accordingly, the size distribution of the droplets may also be configured to suit the particle size distribution to help ensure that suitable numbers of different size droplets are available based on, related to, dependent upon or in proportion to the different sizes of the particles.

The first atomizer and/or the second atomizer may be configured to produce droplets which have the droplet size distribution which overlaps the particle size distribution of the combustion particles to be removed from the combusted effluent stream. Hence, the size distributions may not exactly match but may simply overlap or have sizes in common in order to promote combining or adhesion between the droplets and the combustion particles. Equally, although the droplet sizes may be a multiple of the particle sizes (for example the droplet sizes may be up to 200 times the size of the particle sizes) the size distribution profiles of the droplets compared to the particles may overlap or share common portions.

The first atomizer and/or the second atomizer may be configured to produce droplets which have the droplet size distribution which matches the particle size distribution of the combustion particles to be removed from the combusted effluent stream. Although the droplet sizes may be a multiple of the particle sizes (for example the droplet sizes may be up to 200 times the size of the particle sizes) the size distribution profiles of the droplets compared to the particles may match or have a similar profile.

The first atomizer and/or the second atomizer may be configured to produce droplets which have a droplet size which is up to 200 times and preferably up to 20 times the particle size of the effluent particles to be removed from the combusted effluent stream. Hence, the relative sizes need not exactly match. The relative sizes may be different by multiples. It has been found that a relative size difference of up to 200 times still promotes suitable adhesion or combining of combustion particles and droplets to cause removal from the combusted effluent stream.

The first atomizer and/or the second atomizer may be configured to produce droplets which have a droplet size which is between 20 and 50 times the particle size of the effluent particles to be removed from the combusted effluent stream.

The first atomizer and/or the second atomizer may be configured to produce droplets within the droplet size distribution having a size which matches particles within the particle size distribution of the combustion particles to be removed from the combusted effluent stream.

The first atomizer and/or the second atomizer may comprise a plurality of nozzles configured to produce the droplets. This allows for an increased number and spatial distribution of the droplets.

The plurality of nozzles may be supplied with an atomizing liquid and an atomizing gas to produce the droplets. Adjusting the atomising liquid and the atomising gas helps to adjust the size and size distribution of the droplets.

The plurality of nozzles may be arranged in parallel with a source of the atomising liquid and a source of the atomising gas to produce the droplets with a matching droplet size distribution from each nozzle.

The plurality of nozzles may be configured to produce the droplets with a differing droplet size distribution from each nozzle. Accordingly, each nozzle may produce a different droplet size distribution which together produces the required droplet size distribution to suit the combusted effluent stream.

The plurality of nozzles may be arranged in groups, each group being arranged in parallel with a source of the atomising liquid and a source of the atomising gas to produce the droplets with a matching droplet size distribution from each group of nozzles.

The nozzles in each group may be arranged in series with the source of the atomising liquid and the source of the atomising gas to produce the droplets with a differing droplet size distribution from each nozzle within that group.

The plurality of nozzles may be arranged in series with a source of the atomising liquid and a source of the atomising gas to produce the droplets with a differing droplet size distribution from each nozzle. Pressure drops between the nozzles may assist in producing different size distributions at different nozzles.

The source of atomizing liquid may be supplied to one end of the series and the source of the atomising gas is supplied to another end of the series to produce the droplets with the differing droplet size distribution from each nozzle.

The plurality of nozzles may be located to produce droplets with different sizes at different locations in the effluent stream. The different sizes may be suited to different size particles found in different locations. For example, smaller particles may be present in faster flowing regions of the apparatus such as towards the centre of the packed tower inlet and larger particles may be present in slower moving regions such as towards the edges of the packed tower inlet. Hence, if that example, nozzles configured to produce smaller droplets may be located towards the centre of the packed tower inlet and nozzles configured to produce larger droplets may be located towards the edges of the packed tower inlet.

The nozzles may be orientated to produce the droplets travelling in a direction which is upstream, downstream and/or transverse to that atomiser.

The nozzles may be orientated to produce the droplets travelling in a direction which is both upstream and downstream of that atomiser.

The nozzles may be orientated to produce the droplets travelling in a direction which opposes a direction of flow of the combusted effluent stream.

The first atomiser and/or the second atomiser may be supplied with up to 300 litres per minute of atomising gas, preferably up to 250 litres per minute (measured with a flow device set to 0° C.).

The first atomiser and/or the second atomiser may be supplied with the atomising gas at a pressure of up to 10 bar, preferably up to 6 bar.

The first atomiser and/or the second atomiser may be supplied with up to 30 litres per hour of atomising liquid, preferably up to 22 litres per hour.

The first atomiser and/or the second atomiser may be supplied with the atomising liquid at a pressure of up to 2 bar, preferably up to 1.5 bar.

The atomising gas may comprise nitrogen and/or compressed dried air and the atomising liquid may comprise water.

The first atomiser may comprise at least 1 nozzle and the second atomiser may comprise at least 1 nozzle.

The first atomiser may comprise at least 6 nozzles arranged in 3 parallel groups of 2 nozzles with the source of the atomising liquid and the source of the atomising gas.

The first atomiser may comprise at least 7 nozzles arranged in parallel with the source of the atomising liquid and the source of the atomising gas.

According to a second aspect, there is provided an apparatus, comprising: an abatement chamber of an abatement apparatus which treats an effluent stream from a semiconductor processing tool to provide a combusted effluent stream having combustion particles; a first atomiser located downstream of the abatement chamber, the first atomiser being configured to produce droplets to entrain at least some of the combustion particles; and a second atomiser located downstream of the first atomiser, the second atomiser being configured to produce droplets to entrain at least some of the combustion particles.

The second aspect recognizes that a problem with existing arrangements is that the amount of effluent particles that can be removed from the effluent stream is limited. This may be because the particles remain suspended within the combusted effluent stream and so are difficult to remove.

Accordingly, an apparatus is provided. The apparatus may comprise an abatement chamber. The abatement chamber may be provided as part of an abatement apparatus. The abatement apparatus be configured to treat, process or abate an effluent stream provided by a semiconductor processing tool. The abatement chamber may provide or produce a combusted effluent stream. The combusted effluent stream may have effluent particles suspended therein. The apparatus may comprise a first atomizer which may receive the combusted effluent stream from the abatement chamber. The first atomizer may be configured or arranged to produce droplets. The droplets may entrain, capture, adhere or join with at least some of the combustion particles. The apparatus may comprise a second atomizer. The second atomiser may be positioned downstream or away from the first atomiser. The second atomiser may receive the combusted effluent stream from the first atomiser. The second atomizer may be configured or arranged to produce droplets. The droplets may entrain, capture, adhere or join with at least some of the combustion particles. In this way, the atomizers may produce droplets which combine with or adhere to the effluent particles which assists in the removal of the effluent particles from the combusted effluent stream. Providing a second atomizer enables further droplets to be produced which may combine with effluent particles and/or already combined effluent particles and droplets produced from the first atomizer, which helps to remove these from the combusted effluent stream.

The apparatus may comprise a quench spray section upstream of the first atomiser and a spray nozzle for scrubbing water soluble gases upstream of the second atomiser. Typically, the quench spray section may be located in a quenching stage downstream of the abatement chamber. Typically, the spray nozzle may be located in a packed tower downstream of the first atomizer and upstream of the second atomizer.

The first atomiser may be located downstream of a quenching stage.

The first atomiser may be located towards an entrance of a packed tower.

The second atomiser may be located towards an exhaust of the packed tower.

The second atomiser may be located upstream of one of a cyclone stage and a mist filter.

The first atomiser and/or the second atomiser may be configured to produce droplets which have a droplet size distribution based on a particle size distribution of the effluent particles to be removed from the combusted effluent stream.

The first atomiser and/or the second atomiser may be configured to produce droplets have the droplet size distribution which overlaps the particle size distribution of the combustion particles to be removed from the combusted effluent stream. Equally, although the droplet sizes may be a multiple of the particle sizes (for example the droplet sizes may be up to 200 times the size of the particle sizes) the size distribution profiles of the droplets compared to the particles may overlap or share common portions.

The first atomiser and/or the second atomiser may be configured to produce droplets which have the droplet size distribution which matches the particle size distribution of the combustion particles to be removed from the combusted effluent stream. Although the droplet sizes may be a multiple of the particle sizes (for example the droplet sizes may be up to 200 times the size of the particle sizes) the size distribution profiles of the droplets compared to the particles may match or have a similar profile.

The first atomiser and/or the second atomiser may be configured to produce droplets which have a droplet size which is up to 200 times and preferably up to 20 times the particle size of the effluent particles to be removed from the combusted effluent stream.

The first atomizer and/or the second atomizer may be configured to produce droplets which have a droplet size which is between 20 and 50 times the particle size of the effluent particles to be removed from the combusted effluent stream.

The first atomiser and/or the second atomiser may be configured to produce droplets within the droplet size distribution having a size which matches particles within the particle size distribution of the combustion particles to be removed from the combusted effluent stream.

The first atomiser and/or the second atomiser may comprise a plurality of nozzles configured to produce the droplets.

The plurality of nozzles may be supplied with an atomising liquid and an atomising gas to produce the droplets.

The plurality of nozzles may be arranged in parallel with a source of the atomising liquid and a source of the atomising gas to produce the droplets with a matching droplet size distribution from each nozzle.

The plurality of nozzles may be configured to produce the droplets with a differing droplet size distribution from each nozzle.

The plurality of nozzles may be arranged in groups of nozzles, each group being arranged in parallel with a source of the atomising liquid and a source of the atomising gas to produce the droplets with a matching droplet size distribution from each group of nozzles.

Nozzles in each group may be arranged in series with the source of the atomising liquid and the source of the atomising gas to produce the droplets with a differing droplet size distribution from each nozzle within that group.

The plurality of nozzles may be arranged in series with a source of the atomising liquid and a source of the atomising gas to produce the droplets with a differing droplet size distribution from each nozzle.

The source of the atomising liquid may be supplied to one end of the series and the source of the atomising gas may be supplied to another end of the series to produce the droplets with the differing droplet size distribution from each nozzle.

The plurality of nozzles may be located to produce droplets with different sizes at different locations in the effluent stream.

The nozzles may be orientated to produce the droplets travelling in a direction which is upstream, downstream and/or transverse to that atomiser.

The nozzles may be orientated to produce the droplets travelling in a direction which is both upstream and downstream of that atomiser.

The nozzles may be orientated to produce the droplets travelling in a direction which opposes a direction of flow of the combusted effluent stream.

The first atomiser and/or the second atomiser may be supplied with up to 300 litres per minute of atomising gas, preferably up to 250 litres per minute (measured using a flow device set to 0° C.).

The first atomiser and/or the second atomiser may be supplied with the atomising gas at a pressure of up to 10 bar, preferably up to 6 bar.

The first atomiser and/or the second atomiser may be supplied with up to 30 litres per hour of atomising liquid, preferably up to 22 litres per hour.

The first atomiser and/or the second atomiser may be supplied with the atomising liquid at a pressure of up to 2 bar, preferably up to 1.5 bar.

The atomising gas may comprise nitrogen and/or compressed dried air and the atomising liquid may comprise water.

The first atomiser may comprise at least 1 nozzle and the second atomiser comprises at least 1 nozzle.

The first atomiser may comprise at least 6 nozzles arranged in 3 parallel groups of 2 nozzles with the source of the atomising liquid and the source of the atomising gas.

The first atomiser may comprise at least 7 nozzles arranged in parallel with the source of the atomising liquid and the source of the atomising gas.

According to a third aspect, there is provided a method, comprising: receiving a combusted effluent stream having combustion particles from an abatement chamber of an abatement apparatus which treats an effluent stream from a semiconductor processing tool; and removing combustion particles from the combusted effluent stream using a first atomiser located downstream of the abatement chamber configured to produce droplets having a droplet size based on a particle size of the combustion particles to be removed from the combusted effluent stream.

The method may comprise locating a second atomiser located downstream of the first atomiser.

The method may comprise locating a quench spray section upstream of the first atomiser and locating a spray nozzle for scrubbing water soluble gases upstream of the second atomiser. Typically, the method may comprise locating the quench spray section in a quenching stage downstream of the abatement chamber. Typically, the method may comprise locating the spray nozzle in a packed tower downstream of the first atomizer and upstream of the second atomizer.

The method may comprise locating the first atomiser downstream of a quenching stage.

The method may comprise locating the first atomiser towards an entrance of a packed tower.

The method may comprise locating the second atomiser towards an exhaust of the packed tower.

The method may comprise locating the second atomiser is located upstream of one of a cyclone stage and a mist filter.

The method may comprise configuring the first atomiser and/or the second atomiser to produce droplets which have a droplet size distribution based on a particle size distribution of the effluent particles to be removed from the combusted effluent stream.

The method may comprise configuring the first atomiser and/or the second atomiser to produce droplets have the droplet size distribution which overlaps the particle size distribution of the combustion particles to be removed from the combusted effluent stream.

The method may comprise configuring the first atomiser and/or the second atomiser to produce droplets which have the droplet size distribution which matches the particle size distribution of the combustion particles to be removed from the combusted effluent stream.

The method may comprise configuring the first atomiser and/or the second atomiser to produce droplets which have a droplet size which is up to 200 times and preferably up to 20 times the particle size of the effluent particles to be removed from the combusted effluent stream.

The method may comprise configuring the first atomizer and/or the second atomizer to produce droplets which have a droplet size which is between 20 and 50 times the particle size of the effluent particles to be removed from the combusted effluent stream.

The method may comprise configuring the first atomiser and/or the second atomiser to produce droplets within the droplet size distribution having a size which matches particles within the particle size distribution of the combustion particles to be removed from the combusted effluent stream.

The first atomiser and/or the second atomiser may comprise a plurality of nozzles configured to produce the droplets.

The method may comprise supplying the plurality of nozzles with an atomising liquid and an atomising gas to produce the droplets.

The method may comprise arranging the plurality of nozzles in parallel with a source of the atomising liquid and a source of the atomising gas to produce the droplets with a matching droplet size distribution from each nozzle.

The method may comprise configuring the plurality of nozzles to produce the droplets with a differing droplet size distribution from each nozzle.

The method may comprise arranging the plurality of nozzles in groups of nozzles, each group being arranged in parallel with a source of the atomising liquid and a source of the atomising gas to produce the droplets with a matching droplet size distribution from each group of nozzles.

The method may comprise arranging nozzles in each group arranged in series with the source of the atomising liquid and the source of the atomising gas to produce the droplets with a differing droplet size distribution from each nozzle within that group.

The method may comprise arranging the plurality of nozzles in series with a source of the atomising liquid and a source of the atomising gas to produce the droplets with a differing droplet size distribution from each nozzle.

The method may comprise supplying the source of the atomising liquid to one end of the series and supplying the source of the atomising gas to another end of the series to produce the droplets with the differing droplet size distribution from each nozzle.

The method may comprise locating the plurality of nozzles to produce droplets with different sizes at different locations in the effluent stream.

The method may comprise orientating the nozzles to produce the droplets travelling in a direction which is upstream, downstream and/or transverse to that atomiser.

The method may comprise orientating the nozzles to produce the droplets travelling in a direction which is both upstream and downstream of that atomiser.

The method may comprise orientating the nozzles to produce the droplets travelling in a direction which opposes a direction of flow of the combusted effluent stream.

The method may comprise supplying the first atomiser and/or the second atomiser with up to 300 litres per minute of atomising gas, preferably up to 250 litres per minute (measured from a flow device set to 0° C.).

The method may comprise supplying the first atomiser and/or the second atomiser with the atomising gas at a pressure of up to 10 bar, preferably up to 6 bar.

The method may comprise supplying the first atomiser and/or the second atomiser with up to 30 litres per hour of atomising liquid, preferably up to 22 litres per hour.

The method may comprise supplying the first atomiser and/or the second atomiser with the atomising liquid at a pressure of up to 2 bar, preferably up to 1.5 bar.

The atomising gas may comprise nitrogen and/or compressed dried air and the atomising liquid comprises water.

The first atomiser may comprise at least 1 nozzle and the second atomiser comprises at least 1 nozzle.

The first atomiser may comprise at least 6 nozzles arranged in 3 parallel groups of 2 nozzles with the source of the atomising liquid and the source of the atomising gas.

The first atomiser may comprise at least 7 nozzles arranged in parallel with the source of the atomising liquid and the source of the atomising gas.

The method may comprise conveying the combusted effluent stream with the droplets from the first atomiser towards the second atomiser to agglomerate at least some of the droplets and at least some of the effluent particles.

According to a fourth aspect, there is provided a method, comprising: receiving a combusted effluent stream having combustion particles from an abatement chamber of an abatement apparatus which treats an effluent stream from a semiconductor processing tool; and removing combustion particles from the combusted effluent stream using a first atomiser located downstream of the abatement chamber configured to produce droplets to entrain at least some of the combustion particles and a second atomiser located downstream of the first atomiser, the second atomiser being configured to produce droplets to entrain at least some of the combustion particles.

The method may comprise locating a quench spray section upstream of the first atomiser and locating a spray nozzle for scrubbing water soluble gases upstream of the second atomiser. Typically, the method may comprise locating the quench spray section in a quenching stage downstream of the abatement chamber. Typically, the method may comprise locating the spray nozzle in a packed tower downstream of the first atomizer and upstream of the second atomizer.

The method may comprise locating the first atomiser downstream of a quenching stage.

The method may comprise locating the first atomiser towards an entrance of a packed tower.

The method may comprise locating the second atomiser towards an exhaust of the packed tower.

The method may comprise locating the second atomiser upstream of one of a cyclone stage and a mist filter.

The method may comprise configuring the first atomiser and/or the second atomiser to produce droplets which have a droplet size distribution based on a particle size distribution of the effluent particles to be removed from the combusted effluent stream.

The method may comprise configuring the first atomiser and/or the second atomiser to produce droplets have the droplet size distribution which overlaps the particle size distribution of the combustion particles to be removed from the combusted effluent stream.

The method may comprise configuring the first atomiser and/or the second atomiser to produce droplets which have the droplet size distribution which matches the particle size distribution of the combustion particles to be removed from the combusted effluent stream.

The method may comprise configuring the first atomiser and/or the second atomiser to produce droplets which have a droplet size which is up to 200 times and preferably up to 20 times the particle size of the effluent particles to be removed from the combusted effluent stream.

The method may comprise configuring the first atomizer and/or the second atomizer to produce droplets which have a droplet size which is between 20 and 50 times the particle size of the effluent particles to be removed from the combusted effluent stream.

The method may comprise configuring the first atomiser and/or the second atomiser to produce droplets within the droplet size distribution having a size which matches particles within the particle size distribution of the combustion particles to be removed from the combusted effluent stream.

The first atomiser and/or the second atomiser may comprise a plurality of nozzles configured to produce the droplets.

The method may comprise supplying the plurality of nozzles with an atomising liquid and an atomising gas to produce the droplets.

The method may comprise arranging the plurality of nozzles in parallel with a source of the atomising liquid and a source of the atomising gas to produce the droplets with a matching droplet size distribution from each nozzle.

The method may comprise configuring the plurality of nozzles to produce the droplets with a differing droplet size distribution from each nozzle.

The method may comprise arranging the plurality of nozzles in groups of nozzles, each group being arranged in parallel with a source of the atomising liquid and a source of the atomising gas to produce the droplets with a matching droplet size distribution from each group of nozzles.

The method may comprise arranging nozzles in each group in series with the source of the atomising liquid and the source of the atomising gas to produce the droplets with a differing droplet size distribution from each nozzle within that group.

The method may comprise arranging the plurality of nozzles in series with a source of the atomising liquid and a source of the atomising gas to produce the droplets with a differing droplet size distribution from each nozzle.

The method may comprise supplying the source of the atomising liquid to one end of the series and supplying the source of the atomising gas to another end of the series to produce the droplets with the differing droplet size distribution from each nozzle.

The method may comprise locating the plurality of nozzles to produce droplets with different sizes at different locations in the effluent stream.

The method may comprise orientating the nozzles to produce the droplets travelling in a direction which is upstream, downstream and/or transverse to that atomiser.

The method may comprise orientating the nozzles to produce the droplets travelling in a direction which is both upstream and downstream of that atomiser.

The method may comprise orientating the nozzles to produce the droplets travelling in a direction which opposes a direction of flow of the combusted effluent stream.

The method may comprise supplying the first atomiser and/or the second atomiser with up to 300 litres per minute of atomising gas, preferably up to 250 litres per minute (measured using a flow device set to 0° C.).

The method may comprise supplying the first atomiser and/or the second atomiser with the atomising gas at a pressure of up to 10 bar, preferably up to 6 bar.

The method may comprise supplying the first atomiser and/or the second atomiser with up to 30 litres per hour of atomising liquid, preferably up to 22 litres per hour.

The method may comprise supplying the first atomiser and/or the second atomiser with the atomising liquid at a pressure of up to 2 bar, preferably up to 1.5 bar.

The atomising gas may comprise nitrogen and/or compressed dried air and the atomising liquid comprises water.

The first atomiser may comprise at least 1 nozzle and the second atomiser comprises at least 1 nozzle.

The first atomiser may comprise at least 6 nozzles arranged in 3 parallel groups of 2 nozzles with the source of the atomising liquid and the source of the atomising gas.

The first atomiser may comprise at least 7 nozzles arranged in parallel with the source of the atomising liquid and the source of the atomising gas.

The method may comprise conveying the combusted effluent stream with the droplets from the first atomiser towards the second atomiser to agglomerate at least some of the droplets and at least some of the effluent particles.

According to a fifth aspect, there is provided a method, comprising: determining a particle size of combustion particles to be removed from a combusted effluent stream from an abatement chamber of an abatement apparatus which treats an effluent stream from a semiconductor processing tool; and configuring a first atomiser located downstream of the abatement chamber to produce droplets having a droplet size based on a particle size of the combustion particles to be removed from the combusted effluent stream.

The method may comprise configuring a second atomiser located downstream of the first atomiser to produce droplets having a droplet size based on a particle size of the combustion particles to be removed from the combusted effluent stream.

The method may comprise locating a quench spray section upstream of the first atomiser and locating a spray nozzle for scrubbing water soluble gases upstream of the second atomiser. Typically, the method may comprise locating the quench spray section in a quenching stage downstream of the abatement chamber. Typically, the method may comprise locating the spray nozzle in a packed tower downstream of the first atomizer and upstream of the second atomizer.

The method may comprise locating the first atomiser downstream of a quenching stage.

The method may comprise locating the first atomiser towards an entrance of a packed tower.

The method may comprise locating the second atomiser towards an exhaust of the packed tower.

The method may comprise locating the second atomiser upstream of one of a cyclone stage and a mist filter.

The method may comprise configuring the first atomiser and/or the second atomiser to produce droplets which have a droplet size distribution based on a particle size distribution of the effluent particles to be removed from the combusted effluent stream.

The method may comprise configuring the first atomiser and/or the second atomiser to produce droplets which have the droplet size distribution which overlaps the particle size distribution of the combustion particles to be removed from the combusted effluent stream.

The method may comprise configuring the first atomiser and the second atomiser to produce droplets which have the droplet size distribution which matches the particle size distribution of the combustion particles to be removed from the combusted effluent stream.

The method may comprise configuring the first atomiser and/or the second atomiser to produce droplets which have a droplet size which is up to 200 times and preferably up to 20 times the particle size of the effluent particles to be removed from the combusted effluent stream.

The method may comprise configuring the first atomizer and/or the second atomizer to produce droplets which have a droplet size which is between 20 and 50 times the particle size of the effluent particles to be removed from the combusted effluent stream.

The method may comprise configuring the first atomiser and/or the second atomiser to produce droplets within the droplet size distribution having a size which matches particles within the particle size distribution of the combustion particles to be removed from the combusted effluent stream.

The first atomiser and/or the second atomiser may comprise a plurality of nozzles configured to produce the droplets.

The method may comprise comprising supplying the plurality of nozzles with an atomising liquid and an atomising gas to produce the droplets.

The method may comprise arranging the plurality of nozzles in parallel with a source of the atomising liquid and a source of the atomising gas to produce the droplets with a matching droplet size distribution from each nozzle.

The method may comprise configuring the plurality of nozzles to produce the droplets with a differing droplet size distribution from each nozzle.

The method may comprise arranging the plurality of nozzles in groups of nozzles, each group being arranged in parallel with a source of the atomising liquid and a source of the atomising gas to produce the droplets with a matching droplet size distribution from each group of nozzles.

The method may comprise arranging nozzles in each group arranged in series with the source of the atomising liquid and the source of the atomising gas to produce the droplets with a differing droplet size distribution from each nozzle within that group.

The method may comprise arranging the plurality of nozzles in series with a source of the atomising liquid and a source of the atomising gas to produce the droplets with a differing droplet size distribution from each nozzle.

The method may comprise supplying the source of the atomising liquid to one end of the series and supplying the source of the atomising gas to another end of the series to produce the droplets with the differing droplet size distribution from each nozzle.

The method may comprise locating the plurality of nozzles to produce droplets with different sizes at different locations in the effluent stream.

The method may comprise orientating the nozzles to produce the droplets travelling in a direction which is upstream, downstream and/or transverse to that atomiser.

The method may comprise orientating the nozzles to produce the droplets travelling in a direction which is both upstream and downstream of that atomiser.

The method may comprise orientating the nozzles to produce the droplets travelling in a direction which opposes a direction of flow of the combusted effluent stream.

The method may comprise supplying the first atomiser and/or the second atomiser with up to 300 litres per minute of atomising gas, preferably up to 250 litres per minute (measured using flow device set to 0° C.).

The method may comprise supplying the first atomiser and/or the second atomiser with the atomising gas at a pressure of up to 10 bar, preferably up to 6 bar.

The method may comprise supplying the first atomiser and/or the second atomiser with up to 30 litres per hour of atomising liquid, preferably up to 22 litres per hour.

The method may comprise supplying the first atomiser and/or the second atomiser with the atomising liquid at a pressure of up to 2 bar, preferably up to 1.5 bar.

The atomising gas may comprise nitrogen and/or compressed dried air and the atomising liquid comprises water.

The first atomiser may comprise at least 1 nozzle and the second atomiser comprises at least 1 nozzle.

The first atomiser may comprise at least 6 nozzles arranged in 3 parallel groups of 2 nozzles with the source of the atomising liquid and the source of the atomising gas.

The first atomiser may comprise at least 7 nozzles arranged in parallel with the source of the atomising liquid and the source of the atomising gas.

The method may comprise configuring the apparatus to convey the combusted effluent stream with the droplets from the first atomiser towards the second atomiser to agglomerate at least some of the droplets and at least some of the effluent particles.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

The Summary is provided to introduce a selection of concepts in a simplified form that are further described in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

Embodiments of the present invention will now be described further, with reference to the accompanying drawings, in which:

FIG. 1 illustrates an abatement apparatus according to one embodiment;

FIG. 2 illustrates an example atomiser arrangement;

FIG. 3 is a graph of total nitrogen flow through the atomisers in litres per minute (measured using a flow device set to 0° C.) against the overall powder removal;

FIG. 4 is a graph showing aerodynamic diameter of particle at 50% impactor cutpoint in μm against normalised sample powder collected from the exhaust;

FIG. 5 is a graph of time in hours against percentage particle removal efficiency;

FIG. 6 illustrates the various atomiser configurations mentioned in FIG. 5;

FIG. 7 shows a comparison of results from the gravimetric testing setup; and

FIG. 8 is a graph showing aerodynamic diameter of particle at 50% impactor cutpoint in μm against average sample powder collected from the exhaust.

### DETAILED DESCRIPTION

Before discussing embodiments in any more detail, first an overview will be provided. Embodiments provide an arrangement where droplets are produced and introduced into the flow of the effluent stream, downstream from an abatement chamber. These droplets combine with or adhere to typically solid particles in the effluent stream which helps to trap or entrain those particles in a fluid within the abatement apparatus. The adhesion of droplets to the particles enhances as the relative size difference between the droplets and the particles decreases. Also, increasing the residence time of the particles in the effluent stream in an environment where the particles and droplets can interact helps to increase the probability of adhesion between droplets and particles, as well as increasing the likelihood of agglomerations between other droplets and particles occurring, which helps to increase their mass and increase the likelihood that the particles will be entrained within the fluid of the abatement apparatus. Hence, providing droplets of the appropriate sizes to adhere with the particles within the effluent stream helps entrain the particles within the abatement apparatus (and remove the particles from the effluent stream leaving abatement system). This leads to fewer particulates in effluent stream and a cleaner environment. Similarly, providing an opportunity for particles and droplets to agglomerate also helps to entrain particles within the abatement apparatus.

### Abatement Apparatus

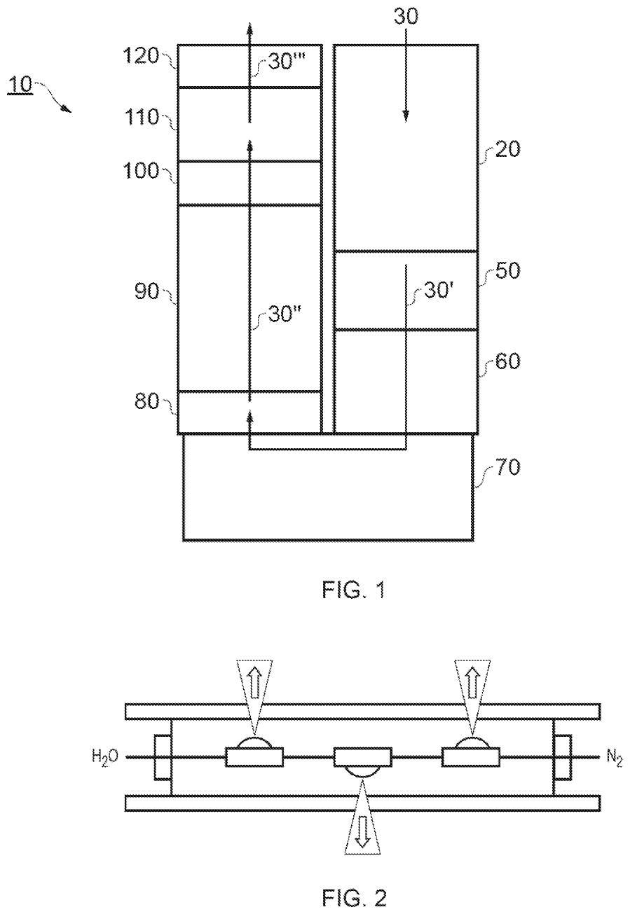

FIG. 1 illustrates an abatement apparatus 10 according to one embodiment. An abatement chamber 20 is provided which receives an effluent stream 30 from a semiconductor processing tool (not shown). As mentioned above, the effluent stream 30 may contain gas and particulate matter. The abatement chamber 20 is typically comprised of a foraminous burner, open flame burner, an electrically heated thermal processing unit or a plasma chamber, as required to perform thermal and chemical abatement of the effluent stream 30 and produce a combusted effluent stream 30′. The combusted effluent stream 30′ contains particles which are desired to be removed. Typically, the aim is to remove 90% of particles having a particle diameter of less than 2.5 microns. Downstream of the abatement chamber 20 is a weir stage 50 where the combusted effluent stream 30′ passes through a conduit surrounded by a weir of flowing water. Downstream of the weir stage 50 is a quench stage 60 where water is sprayed in a direction transverse to the flow of the combusted effluent stream 30′. Downstream of the quench stage 60 is a tank 70 which acts as a sump for water within the abatement apparatus 10 and through which the combusted effluent stream 30′ flows. Downstream of the tank 70 is a lower atomiser 80, which produces droplets through which the combusted effluent stream 30′ flows, to help remove particles suspended within the combusted effluent stream 30′ of a particular size. The droplets adhere to particles which are of a similar size, causing the particles to fall into the sump due to the increase in mass. Other smaller particles agglomerate in the effluent stream 30″, as will be explained in more detail below. Downstream of the lower atomizer 80 is a packed tower 90. The packed tower 90 typically contains pall rings which fills the packed tower 90 and which are wetted again by water flowing from the top of the packed tower 90 downwards, against the flow of the agglomerated effluent stream 30″, through the lower atomizer 80 and then into the tank 70 for recirculation. The water in the tank 70 is recirculated to the packed tower 90, weir stage 50 and quench stage 60. Downstream of the packed tower 90 is an upper atomizer 100 which produces droplets through which the agglomerated effluent stream 30″ flows to help remove particles, mostly agglomerated and grown, suspended within the agglomerated effluent stream 30″, as will be explained in more detail below. Downstream of the upper atomizer 100 is a cyclone stage 110 which contains one or more cyclones or a mist pad which receive the agglomerated effluent stream 30″ and helps to remove particles/water/moisture suspended within the agglomerated effluent stream 30″ and produce a treated effluent stream 30′″. Downstream of the cyclone stage 110 is a packed tower lid 120 which has an exhaust system through which the treated effluent stream 30′″ is vented to extract facilities.

In operation, the effluent stream 30 (which contains gas and may contain solid components or particles) is received by the abatement chamber 20 at an inlet and is exhausted as the combusted effluent stream 30′ (which also contains gas and solid components or particles) at an outlet into the weir stage 50. The combusted effluent stream 30′ travels through the weir stage 50 and the quench stage 60 where it is cooled. The quench nozzles remove a proportion of the particles produced from the process chemistry abatement. The cooled combusted effluent stream 30′ exits the quench stage 60 and travels through the tank 70 to the lower atomizer 80.

The lower atomizer 80 produces droplets of water. Those droplets adhere to particles within the combusted effluent stream 30′ to produce the agglomerated effluent stream 30″. The agglomerated effluent stream 30″ now contains gaseous and solid components or particles, combined particles and droplets, as well as agglomerated particles and droplets. If they increase to a sufficient mass, they then fall out of suspension from the agglomerated effluent stream 30″.

As the agglomerated effluent stream 30″ passes through the packed tower 90, some of the gaseous components dissolve into the water flowing through the packed tower 90. In addition, some of the particles, combined particles and droplets and agglomerated particles within the agglomerated effluent stream 30″ adhere to the wetted surfaces within the packed tower 90, which is washed away by the packed tower spray. In addition, the size of the agglomerated particles within the agglomerated effluent stream 30″ increases as they combine when traveling through the packed tower 90 from the lower atomizer 80 to the upper atomizer 100. If they increase to a sufficient mass, they then fall out of suspension from the agglomerated effluent stream 30″.

The agglomerated effluent stream 30″ passes through the upper atomizer 100 which also generates droplets. Some of these droplets combine with some of the particles, combined particles and droplets and agglomerated particles still within the agglomerated effluent stream 30″ as they pass through the upper atomizer 100. If they increase to a sufficient mass, they then fall out of suspension from the agglomerated effluent stream 30″. In addition, some of the droplets produced by the upper atomizer 100 fall into the packed tower 90 to interact with the agglomerated effluent stream 30″ passing through the packed tower 90.

In this way, the lower atomizer 80 helps to remove a proportion of the particles within the combusted effluent stream 30″ by producing droplets which adhere to those particles and, either as a direct result or through agglomeration with other particles, increases their mass so that they travel against the flow and fall back towards the tank 70. Likewise, some of the remaining particles, combined particles and droplets and agglomerated particles may be directly trapped by the wetted surface within the packed tower 90. The probability of such adherence or falling out of suspension occurring increases as droplets and particles travel through the packed tower 90 since their combining and agglomeration increases as they travel through the packed tower 90. Any remaining particles, combined particles and droplets and agglomerated particles left then are subjected to a further influx of droplets from the upper atomizer 100 which again combine with a proportion of the remaining particles and/or agglomerated particles still within the agglomerated effluent stream 30″. Some of these either fall back into the packed tower 90 or travel to the cyclone 110. Again, as the remaining particles, combined particles and droplets and agglomerated particles travel towards the cyclone stage 110, the proportion of agglomerated particles increases, as does the mass of those agglomerated particles. This increases the performance of the upper atomiser 100 since particles that are not removed by the lower atomiser 80 are now separated by the upper atomiser 100. The cyclone stage 110 removes particles/water/moisture carried by the effluent stream 30″. As a result, the treated effluent stream 30′″ being vented from the packed tower lid 120 has a very little particulate content.

In one experiment, a four inlet abatement apparatus 10 was supplied with 0.25 litres per minute of silane at 1 bar. Silica powder produced from silane combustion was then measured using an electrical low pressure impactor (ELPI+ (Registered Trade Mark)) which provides particle size spectrometry for real-time particle measurements. The nozzles in the atomizers used nitrogen or air to disperse water into smaller droplets. The higher the flow and pressure of N2/air supply to the atomizing nozzle, the smaller the water droplet created. In the experiments described herein, the nozzle used is an atomizing spray setup SU26 from Spraying Systems Company (Registered Trade Mark). The SU26 setup consists of a fluid cap 60100 and an air cap 140-6-37-70° fitted to a standard air atomizer nozzle body. The upper atomizer 100 is fitted above the packed tower 90 and has a spool splitting a single supply of water and nitrogen to two SU26 nozzles pointing towards the packed tower 90 and one SU26 nozzle pointing towards the cyclone stage 110 to allow for wetting of the cyclone stage 110 to improve its efficiency, as illustrated in FIG. 2. The lower atomizer 80 is fitted below the packed tower 90 and has a spool splitting water and nitrogen to three SU26 nozzles orientated to point towards the tank 70.

The detailed arrangement and operation of nozzles can be suited to the conditions within the apparatus. For example, an assessment or determination of the expected particle sizes, size distribution and quantity or rate can be made for the abatement apparatus. Additionally, a determination can be made of how those are expected to be distributed at the different locations within the abatement apparatus. The atomisers can then be located, configured and operated to produce suitably sized, suitably sized-distributed and suitable quantities of droplets for those expected particles.

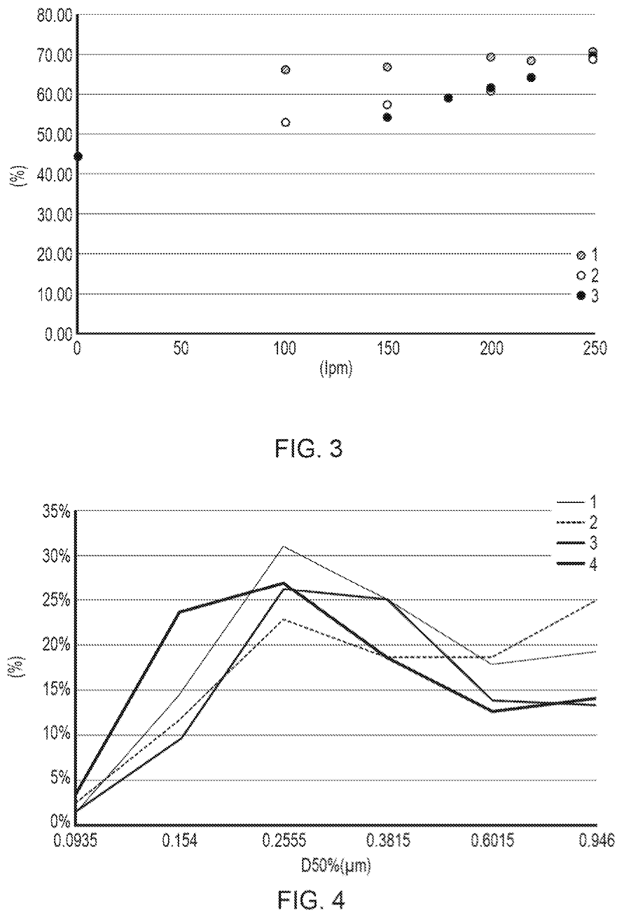

FIG. 3 is a graph of total nitrogen flow through the atomisers in litres per minute against the overall % powder removal from the system and shows the performance of the upper atomizer 100 and the lower atomizer 80 when operated individually and with varied nitrogen flows between 150 and 250 litres per minute. Points 1 are for stainless steel nozzles in the upper atomiser 100, points 2 are for stainless steel nozzles in the lower atomiser 80 and points 3 are for are for plastic nozzles in the lower atomiser 80. The total supply of nitrogen (supplied at a 6 bar pressure) to the atomizing spool was varied to investigate the changing water droplet size. The graph shows the testing of the upper atomizer 100 and the lower atomizer 80 when operated independently. As can be seen, the performance of the upper atomizer 100 with increasing nitrogen flow (and reduced water flow) to the three nozzles is fairly constant (increasing the nitrogen flow to the top atomiser did not have a significant improvement on the particle removal efficiency). With 6 bar pressure nitrogen supplied at 100 litres per minute to the upper atomiser 100, there is 66% powder removal compared with 70% at 250 litres per minute. Therefore, providing 180 litres per minute at 6 bar of nitrogen and 1 litre per minute of water at 1.5 bar to the upper atomizer 100 can be adequate. Tests have shown that orientating the upper atomizer 100 to have three nozzles pointing back towards the packed tower 90 and opposing the flow of the agglomerated effluent stream 30″ increases the amount of powder removal. As can also be seen, the lower atomizer 80 has a lower powder removal than the upper atomizer 100, except at 250 litres per minute of nitrogen flow. As can also be seen, plastic nozzles show comparable performance to the stainless steel nozzles, and so the nozzle material does not appear to influence powder removal.

TABLE 1

| | ATSP | SiO2 | | | | |
|---|---|---|---|---|---|---|
| | N2 flow | Input | SiO2 output | | | |
| Atlas setup | (slm) | mg/min | mg/min | mg/m3 | PRE % | Method |
| without | 0 | 675 | 390 | 758.4 | 42.2% | ELPI+ |
| ATSP | | | | | | |
| Top ATSP | 150 | 675 | 227.7 | 343.0 | 66.3% | ELPI+ |
| Top ATSP | 200 | 675 | 212.6 | 297.8 | 68.5% | ELPI+ |
| Top ATSP | 220 | 675 | 218.2 | 297.3 | 67.7% | ELPI+ |
| Bottom ATSP | 150 | 675 | 292 | 440.0 | 56.7% | ELPI+ |
| Bottom ATSP | 200 | 675 | 268.8 | 376.5 | 60.2% | ELPI+ |
| Bottom ATSP | 250 | 675 | 216.1 | 338.4 | 68.0% | ELPI+ |
| Dual ATSP | 180 | 675 | 200.59 | 229.5 | 70.3% | ELPI+ |
| Dual ATSP | 200 | 675 | 185.5 | 202.9 | 72.5% | ELPI+ |
| Dual ATSP | 220 | 675 | 174.9 | 183.3 | 74.1% | ELPI+ |
| Dual ATSP | 250 | 675 | 162.3 | 160.1 | 76.0% | ELPI+ |

Table 1 shows silica powder removal as a percentage for different atomizer positions (Dual ATSP is both atomisers operating, Top ATSP is the upper atomiser 100 operating and Bottom ATSP is the lower atomiser 80 operating). As can be seen, the best configuration achieves a 76% powder removal. This is achieved with the upper atomizer 100 and the lower atomizer 80 both operated with the upper atomizer 100 supplied with 250 litres per minute of nitrogen at 6 bar and approximately 22 litres per hour of water at 1.5 bar, with the lower atomizer 80 being supplied with 250 litres per minute of nitrogen at 6 bar and approximately 25 litres per hour of water at 1.5 bar.

However, the best configuration, when tested gravimetrically (repeated two times) provided an average performance of 82.1% powder removal, rather than the 76% removal shown in Table 1.

FIG. 4 is a graph showing aerodynamic particle diameter at 50% impactor cutpoint in μm against normalised mass of sample powder collected from the exhaust in %, illustrating the normalised mass of particle size distribution and comparing the results from various atomizer configurations. Line 1 illustrates the performance with no atomizers operating but with the abatement apparatus 10 comprising the abatement chamber 20, weir stage 50, quench stage 60, tank 70 and packed tower 90 on and with forward flow of the effluent stream 30. Line 2 shows the performance of the abatement apparatus 10 with addition of the lower atomizer 80 when operating with 250 litres per minute of nitrogen. Line 3 shows the performance of the abatement apparatus 10 with addition of the upper atomizer 100 operating at 250 litres per minute of nitrogen. Line 4 shows the operation of the abatement apparatus 10 with both the lower atomizer 80 and the upper atomizer 100 when operating with 250 litres per minute of nitrogen. The results show that with the upper atomizer 100 there are fewer large particles (0.6 microns) measured in the exhaust than without the upper atomizer 100 operating. There is a higher quantity of particles with diameter 0.225 microns, although this may be a result of capturing (and so removing from the exhaust) the larger particles which magnifies the proportion of smaller particles appearing in the exhaust. The lower atomizer 80 exhibits an increased concentration of larger particles leaving via the exhaust (particle size greater than 0.255 microns). Operating both the lower atomizer 80 and the upper atomizer 100 appears to shift the particle to size distribution towards a smaller particle size. Here, an increased concentration of 0.154 and 0.255 micron particles are observed in the exhaust but, again, because this is a normalized distribution the absolute numbers of smaller particles are reduced, as demonstrated in Table 1 and through the gravimetric testing.

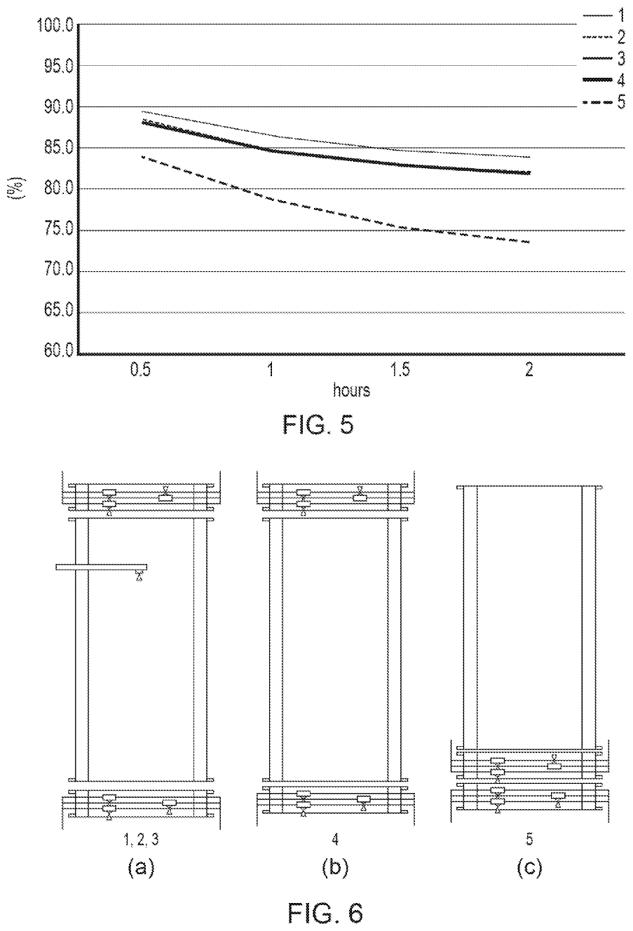

FIG. 5 is a graph of time in hours against percentage particle removal efficiency and illustrates the performance impact the packed tower 90 has on the arrangement which utilizes both a lower atomizer 80 and an upper atomizer 100. The testing was completed over a two-hour period. Line 1 represents the results for both the lower atomizer 80 and the upper atomizer 100 operating but with the fluid in the tank 70 already containing a lot of powder (the water was white). Line 2 represents the results for both the lower atomizer 80 and the upper atomizer 100 operating but with clean fluid in the tank 70. However, this has the same trend as an arrangement shown for lines 3 (which omits the pall rings and spray) and line 4 (which just omits the pall rings). However, the effect of removing the pall rings and/or spray is to drastically reduce the surface area within the packed tower 90 which impacts on the removal of water-soluble gases from the agglomerated effluent stream 30″. The packed tower spray is a water-only spray which produces water droplets which are significantly greater in size than the particles in the agglomerated effluent stream 30″, hence it can be seen that the presence of the pall rings and the spray within the packed tower 90 has a marginal effect on the removal of particles from within the agglomerated effluent stream 30″.

FIG. 6 illustrates the various configurations mentioned in FIG. 5. In particular, FIG. 6A shows the configuration for lines 1, 2 and 4, FIG. 6B shows the configuration for line 3 and FIG. 6C shows the configuration for line 5. As can be seen in FIG. 5, when adopting the configuration shown in FIG. 6C where the packed tower 90 is positioned downstream of both the lower atomizer 80 and the upper atomizer 100, there is around a 10% reduction in powder removal. This suggests that separating the atomizers with a void, either with or without pall rings and a packed tower spray, aids in removing particles. Without wishing to be bound by theory, this suggests that the lower atomizer 80 removes smaller particles or facilitates in the agglomeration of smaller particles. As the agglomerated effluent stream 30″ passes through the packed tower 90, the particles agglomerate, becoming bigger and bigger. Such agglomeration continues and once at a particular size (such as 0.25 microns or larger), the upper atomizer 100 is more effective at removing these particles and such agglomeration continues which may make the cyclone stage 110 also more efficient at removing those particles. This makes the dual atomizer arrangement more efficient as there are two stages of particle removal, after the quench stage 60. This also means that the packed tower space also assists in making the dual atomizer arrangement more efficient at removing particles.

Experimental data shows that with a packed tower arrangement as shown in FIG. 6 (250 mm diameter and a total height of 117 cm) when operating with 500 lpm throughput and a 0.25 lpm silane flow, the powder removal performance did not increase to above that shown for the FIG. 6(c) arrangement (where the lower atomizer 80 and the upper atomizer 100 are adjacent) until the distance between the lower atomizer 80 and the upper atomizer 100 was increased to at least 17.5 cm. This shows that there is agglomeration and therefore growth of the particles as they travel from the lower atomizer 80 to the upper atomizer 100 helps to improve the particle removal performance of the upper atomizer 100. Also, orientating the spray nozzles to oppose the major direction of flow through the packed tower helps slow the flow through the packed tower, which increases residence time and further improves particle removal.

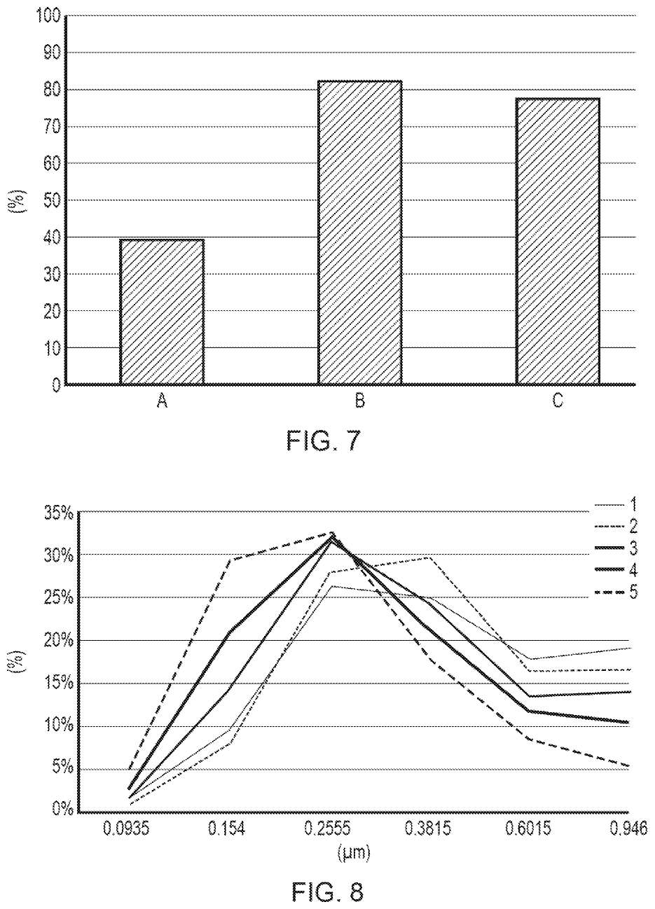

As mentioned above, the data collected using the ELPI+ (Registered Trade Mark) apparatus was validated using a gravimetric method where the apparatus was run with a high-efficiency particulate air (HEPA) filter fitted after a cyclone capable of removing particles >10 microns in the sampling line, taken 60 cm above the packed tower lid 120. The results are shown in FIG. 7 which shows a comparison of results from the gravimetric testing setup. Column A shows the percentage of powder (particles) removed with neither a lower atomizer 80 nor an upper atomizer 100 (powder removal from the abatement system). Column B shows the percentage of powder removed with both the lower atomizer 80 and the upper atomizer 100 present. Column C shows an alternative arrangement which uses a single, 7-nozzle lower atomizer 80.

The single, 7-nozzle lower atomizer 80 captured 77.4% of the powder produced, measured gravimetrically. The 7-nozzle atomizer is an atomizer spool consisting of seven of the SU26 nozzles but with 100 litres per minute of nitrogen at 6 bar and 2.5 litres per hour of water at 1.5 bar supplied to each nozzle, individually via seven inlet supplies. This arrangement was arrived at following testing involving varying the flow gas to a single nozzle to identify the best ratio of nitrogen to water before the water supply became choked (determined by visual inspection). This ratio was then applied to all seven nozzles to see the effect of creating more water droplets of the same size had on the powder removal efficiency.

TABLE 2

| | | | Q air | | | | DV | DV | DV | Axial |
|---|---|---|---|---|---|---|---|---|---|---|
| Nozzle | Z | Q water | (LPM at | Q air | D10 | D32 | 0.1 | 0.5 | 0.9 | Velocity |
| ID | (mm) | (LPH) | 0° C.) | (SCFM) | (μm) | (μm) | (μm) | (μm) | (μm) | (m/s) |
| SU 26 | 150 | 2.5 | 100 | 3.8 | 19.3 | 28.0 | 16.2 | 31.4 | 63.7 | 6.2 |

Table 2 shows the droplet size measured from the nozzles at a distance of 0.15 metres from the nozzle (by nozzle provider Spraying systems (Registered Trade Mark)).

### Definitions

D32—Sauter median diameter, this value is the size of droplet that best represents the overall spray, i.e. the ratio of the volume to the surface area of this size droplet is the same as the overall spray volume to the overall spray surface area.
D10 is a straight (arithmetic) average drop size
DV0.5—Volume median diameter, the spray volume has 50% smaller than this size and 50% larger than this value
DV0.9-90% of the spray volume has droplet size of smaller than or equal to this value

TABLE 3

| | Percentage powder |
|---|---|
| Lower atomiser setup | removal efficiency (%) |
| 7 Nozzles | 76.95 |
| 5 Nozzles | 71.35 |
| 3 Nozzles | 61.10 |
| 1 Nozzle | 49.10 |
| SiH4 Only | 36.21 |

Table 3 shows the results when varying the number of nozzles in operation. As can be seen, the best result is when the 7-nozzle atomizer is used. With a Sauter median diameter of 28 microns, 76.95% of powder is removed.

FIG. 8 is a graph showing the aerodynamic diameter of 50% impactor cutpoint in μm against normalised mass of sample powder collected from the exhaust in % and shows the normalized particle distribution for this test with line 1 having no atomizers, line 2 having 1 nozzle, line 3 having 3 nozzles, line 4 having 5 nozzles and line 5 having 7 nozzles. As can be seen by comparing the particle size distribution of no atomizers to those having atomizers, the particle size distribution shifts left with increasing number of atomizers. Therefore, the production of 28 micron Sauter median diameter droplets can be seen to remove particles greater than 0.3819 microns. Additionally, there appears to be a relationship with the proximity of nozzles, suggesting the shearing of droplets to smaller sizes or agglomeration to larger droplet sizes.

Without wishing to be bound by theory, it is observed that the closer that the droplets are in size to the particles within the effluent stream, the more effective the removal of those particles from the effluent stream. It is considered that the droplets and the particles are more likely to adhere together when they are of similar sizes. The droplets and particles do not need to be of identical size and the adherence appears to occur even when the droplets are a multiple of the size of the particles. For example, particles having a Sauter median diameter of 28 microns appear to adhere to particles of size greater than 0.2555 microns effectively. Hence, droplets which are around 200 times larger than the particles still appear to adhere to those particles. It follows, therefore, that if droplets of a similar size to the particles can be produced then the effectiveness of removal of those particles would increase. It is also observed that the particles will have a particular size distribution within the combusted effluent stream and so it would be advantageous for the droplets to have a similar size distribution in order to maximize the correlation between sizes. This can be achieved by using different nozzles to produce different size droplets and different size distributions. Likewise, as demonstrated by the 7 nozzle atomizer, by producing an extremely high quantity of droplets compared to the number of particles, the adherence between droplets and particles can also be increased due presumably to an increased statistical probability that the two will collide and adhere. It is also observed that even when extremely small particles, when combined with a droplet, still have a mass that would be too small to fall with gravity against the flow of the effluent stream, the combined droplet and particle is more likely to adhere to surfaces within the packed tower and to agglomerate with other droplets and/or particles and/or combined droplets and particles and so grow in size as they travel through the packed tower 90, which increases the likelihood that they will be effectively entrained within the packed tower 90 or combined with further droplets provided by the upper atomizer 100 and achieve a mass which overcomes the flow of the combusted effluent stream due to the effects of gravity and/or improves their removal from the combusted effluent stream by the upper atomiser 100.

In one experiment, a typical measured particle size at the top atomiser (without dual atomisers) is around 433 nm. The measured water droplet size is around 16.2-63.7 μm—measured at a distance of 15 cm away from the spray nozzle (however water droplets will be slightly smaller than this as the maximum space between top atomiser and packed tower is 15 cm and the maximum space between bottom atomiser and tank water height is 15 cm; thus would have been useful for them to measure <15 cm away from the nozzles). This shows that the droplet size is between 20 and 50 times particle size (37 times for 16 μm water droplet).

Hence, in some embodiments, the particle size of the droplets is selected based on the expected size of the particles in the effluent stream. The droplets need not exactly match the size of the particles, but can often be up to 200 times and typically between 20 and 50 times the size of the particles while still promoting adhesion and agglomeration between the droplets and particles. Furthermore, where the expected size distribution of the particles is known, the size distribution of the droplets can be controlled to match at least a portion of that size distribution to ensure that appropriate quantities of appropriate (often relative) sized droplets are available.

Although illustrative embodiments of the invention have been disclosed in detail herein, with reference to the accompanying drawings, it is understood that the invention is not limited to the precise embodiment and that various changes and modifications can be effected therein by one skilled in the art without departing from the scope of the invention as defined by the appended claims and their equivalents.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. An apparatus, comprising:
an abatement chamber of an abatement apparatus which treats an effluent stream from a semiconductor processing tool to provide a combusted effluent stream having effluent particles; and
a first atomiser located downstream of the abatement chamber, said first atomiser being configured to produce droplets having a droplet size based on a particle size of said effluent particles to be removed from said combusted effluent stream wherein said first atomiser comprises a plurality of nozzles configured to produce said droplets and wherein said plurality of nozzles are configured to produce said droplets with a differing droplet size distribution from each nozzle.

2. The apparatus of claim 1, comprising a second atomizer located downstream of the first atomizer.

3. The apparatus of claim 2, wherein at least one of said first atomiser and said second atomiser is configured to produce droplets which have a droplet size distribution based on a particle size distribution of said effluent particles to be removed from said combusted effluent stream.

4. The apparatus of claim 2, wherein at least one of said first atomiser and said second atomiser is configured to produce droplets have said droplet size distribution which overlaps said particle size distribution of said combustion particles to be removed from said combusted effluent stream.

5. The apparatus of claim 2, wherein at least one of said first atomiser and said second atomiser is configured to produce droplets which have said droplet size distribution which matches said particle size distribution of said combustion particles to be removed from said combusted effluent stream.

6. The apparatus of claim 2, wherein at least one of said first atomiser and said second atomiser is configured to produce droplets which have a droplet size which is up to 200 times and preferably up to 20 times said particle size of said effluent particles to be removed from said combusted effluent stream.

7. The apparatus of claim 2, wherein at least one of said first atomiser and said second atomiser is configured to produce droplets within said droplet size distribution having a size which matches particles within said particle size distribution of said combustion particles to be removed from said combusted effluent stream.

8. The apparatus of claim 2, wherein said second atomiser comprises a plurality of nozzles configured to produce said droplets.

9. The apparatus of claim 8, wherein said plurality of nozzles are configured to produce said droplets with a differing droplet size distribution from each nozzle.

10. The apparatus of claim 8, wherein said plurality of nozzles are arranged in series with a source of said atomising liquid and a source of said atomising gas to produce said droplets with a differing droplet size distribution from each nozzle.

11. The apparatus of claim 8, wherein said plurality of nozzles are located to produce droplets with different sizes at different locations in said effluent stream.

12. The apparatus of claim 8, wherein said nozzles are orientated to produce said droplets travelling in a direction which opposes a direction of flow of said combusted effluent stream.

13. An apparatus, comprising:
an abatement chamber of an abatement apparatus which treats an effluent stream from a semiconductor processing tool to provide a combusted effluent stream having combustion particles;
a first atomiser located downstream of the abatement chamber, said first atomiser being configured to produce droplets to entrain at least some of said combustion particles; and
a second atomiser located downstream of said first atomiser, said second atomiser being configured to produce droplets to entrain at least some of said combustion particles wherein at least one of said first atomiser and said second atomiser comprises a plurality of nozzles configured to produce said droplets and wherein said plurality of nozzles are configured to produce said droplets with a differing droplet size distribution from each nozzle.

14. A method, comprising:
receiving a combusted effluent stream having combustion particles from an abatement chamber of an abatement apparatus which treats an effluent stream from a semiconductor processing tool; and
removing combustion particles from said combusted effluent stream using a first atomiser located downstream of the abatement chamber configured to produce droplets having a droplet size based on a particle size of said combustion particles to be removed from said combusted effluent stream wherein said first atomiser comprises a plurality of nozzles configured to produce said droplets and wherein said plurality of nozzles are configured to produce said droplets with a differing droplet size distribution from each nozzle.

15. A method, comprising:
receiving a combusted effluent stream having combustion particles from an abatement chamber of an abatement apparatus which treats an effluent stream from a semiconductor processing tool; and
removing combustion particles from said combusted effluent stream using a first atomiser located downstream of the abatement chamber configured to produce droplets to entrain at least some of said combustion particles and a second atomiser located downstream of said first atomiser, said second atomiser being configured to produce droplets to entrain at least some of said combustion particles wherein at least one of said first atomiser and said second atomiser comprises a plurality of nozzles configured to produce said droplets and wherein said plurality of nozzles are configured to produce said droplets with a differing droplet size distribution from each nozzle.

16. A method, comprising:
determining a particle size of combustion particles to be removed from a combusted effluent stream from an abatement chamber of an abatement apparatus which treats an effluent stream from a semiconductor processing tool; and
configuring a first atomiser located downstream of said abatement chamber to produce droplets having a droplet size based on a particle size of said combustion particles to be removed from said combusted effluent stream wherein said first atomiser comprises a plurality of nozzles configured to produce said droplets and wherein said plurality of nozzles are configured to produce said droplets with a differing droplet size distribution from each nozzle.
